(19) United States
(12) Patent Application Publication
(10) Pub. No.: US 2026/0133543 A1
(43) Pub. Date: May 14, 2026

(54) ONE-HAND OPERATION SYSTEM FOR WATCHES

(71) Applicant: SKIWALK TECHNOLOGY CO., LTD., MIAOLI (TW)

(72) Inventors: TIEN-CHIAO CHANG, MIAOLI (TW); SHIH-SIN LIN, MIAOLI (TW)

(21) Appl. No.: 19/186,180

(22) Filed: Apr. 22, 2025

(30) Foreign Application Priority Data
Nov. 12, 2024 (TW) 113143462

(51) Int. Cl. G04G 21/02; G04G 9/00; G06F 3/01

(52) U.S. Cl. CPC G04G 21/02; G04G 9/007; G04G 21/025; G06F 3/011; G06F 3/017

(57) ABSTRACT

The present invention provides a one-hand operation system for a watch, comprising a smart watch, a multi-axis sensor, an optical sensor, and a processing unit. The smart watch includes an operation unit that displays a time screen and a menu screen. The watch body has a light-transmitting section on one side. The multi-axis sensor is positioned inside the watch body to detect vibration waves generated by pinching and releasing finger movements. The optical sensor, also located inside the watch body and aligned with the light-transmitting section, detects changes in light during finger pinching, releasing, and arm movements. The processing unit is electrically connected to both sensors to receive their signals, process vibration wave and light intensity data, and recognize gestures such as pinching, releasing, or moving the arm. Based on this, the system can unlock, lock, or activate functions via a click.

### BACKGROUND OF THE INVENTION

The present invention relates to smart watches and, more specifically, to a one-hand operation system for watches.

In addition to the time display function of a traditional watch, a smart watch provides interactive functions such as wireless communication, music playback, motion monitoring, and health monitoring, which are not available in traditional watches. As a result, smart watches have become quite popular in recent years. A typical smart watch structure consists of a watch body and a wristband. The watch body is equipped with hardware such as sensors, processors, memory, and software like an operating system and application programs. The watch body's screen can display the user interface and various function options, while the wristband is used to wear the smart watch on the wrist.

The screen of the smart watch is typically a touch screen LCD, allowing users to operate the smart watch by tapping the function options displayed on the screen with their fingers. In other words, users must use both hands to operate the smart watch-one hand must be raised while the other hand's finger touches the screen.

To make the operation more convenient, several companies have recently developed smart watches that can be operated with one hand. For example, the patent for invention U.S. Pat. No. 9,971,313 involves placing multiple sensors on the inside of the watch body and the wristband. Each sensor detects wrist and forearm muscle movements in different positions. When the user performs a specific gesture, the sensors sense the muscle movement generated by the gesture and generate corresponding sensing signals. These signals are transmitted to a processor to generate input values. The processor compares the input values with pre-stored reference values in the memory, and when the selected reference value matches the current input value, the target application performs the corresponding function.

In other words, the pre-stored reference input values in the U.S. Pat. No. 9,971,313 patent define the functions that can be activated by different gestures. The user must perform the predetermined gestures to activate the corresponding functions, resulting in the user needing to memorize a variety of gestures to operate the smart watch smoothly, which remains inconvenient.

### SUMMARY OF THE INVENTION

The main purpose of the present invention is to provide a one-hand operation system for a watch that allows users to control a smart watch with one hand through simple gestures and somatosensory actions without needing to memorize multiple gestures in advance, thereby improving convenience and operational efficiency.

To achieve the aforesaid purpose, the present invention provides a one-hand operation system for a watch comprising a smart watch with a watch body and a watch band. Inside the watch body is an operation unit that can display a time screen and a menu screen on the watch display, with the menu screen containing multiple function blocks. One side of the watch body features a transparent part corresponding to the direction of the finger; a multi-axis sensor is installed inside the watch body to detect the vibration waves generated by pinching and releasing the finger. An optical sensor is also installed in the watch body, corresponding to the transparent part, to detect changes in light during finger pinching, releasing, and arm movement; a processing unit is electrically connected to the multi-axis sensor and the optical sensor, this processing unit consists of a computational module and a control module, the computational module receives detection signals from both sensors and calculates information regarding vibration waves and light intensity for various gestures, the control module, based on these calculations, recognizes finger and arm movements—such as pinching, releasing, or moving the arm—and enables the operation unit to unlock, lock, or activate with a click.

### BRIEF DESCRIPTION OF DRAWINGS

FIG. 1 is a system diagram of a preferred embodiment of the present invention.

FIG. 2 is a schematic diagram of the bottom side of the watch body in a preferred embodiment of the present invention.

FIG. 3 is a schematic diagram of the watch screen displaying the time and the unlock point in a preferred embodiment of the present invention.

FIG. 4 is a schematic diagram of the watch screen displaying a menu and an unlock point in a preferred embodiment of the present invention.

FIGS. 5(a) and 5(b) are waveform diagrams of the multi-axis sensor sampled at 100 Hz at rest and while walking, respectively, in a preferred embodiment of the present invention.

FIGS. 6(a) and 6(b) are waveform diagrams of the multi-axis sensor sampled at 250 Hz at rest and while walking, respectively, in a preferred embodiment of the present invention.

FIG. 7 shows the light intensity waveforms of the optical sensor sampled at 250 Hz in a preferred embodiment of the present invention.

FIGS. 8(a) and 8(b) are waveform diagrams of the resultant acceleration force and the difference in the resultant acceleration force, respectively, of the multi-axis sensor sampled at 250 Hz while walking in a preferred embodiment of the present invention.

FIG. 9 is a waveform diagram of the time-series differences detected by the optical sensor in a preferred embodiment of the present invention.

FIGS. 10(a), 10(b) and 10(c) are an operational flowchart of a preferred embodiment of the present invention.

FIG. 11 is a schematic diagram of a preferred embodiment of the present invention in which the operation unit is unlocked by pinching the finger at the time screen (zoomed-in view of the unlock point).

FIG. 12 is a schematic diagram of a preferred embodiment of the present invention in which the operation unit switches from a time screen to a menu screen.

### DETAILED DESCRIPTION OF THE INVENTION

A preferred embodiment of the present invention is described in detail with reference to the accompanying drawings, as follows:

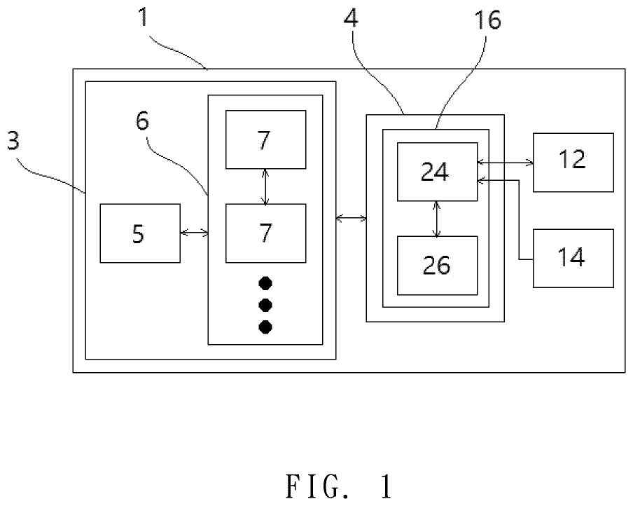

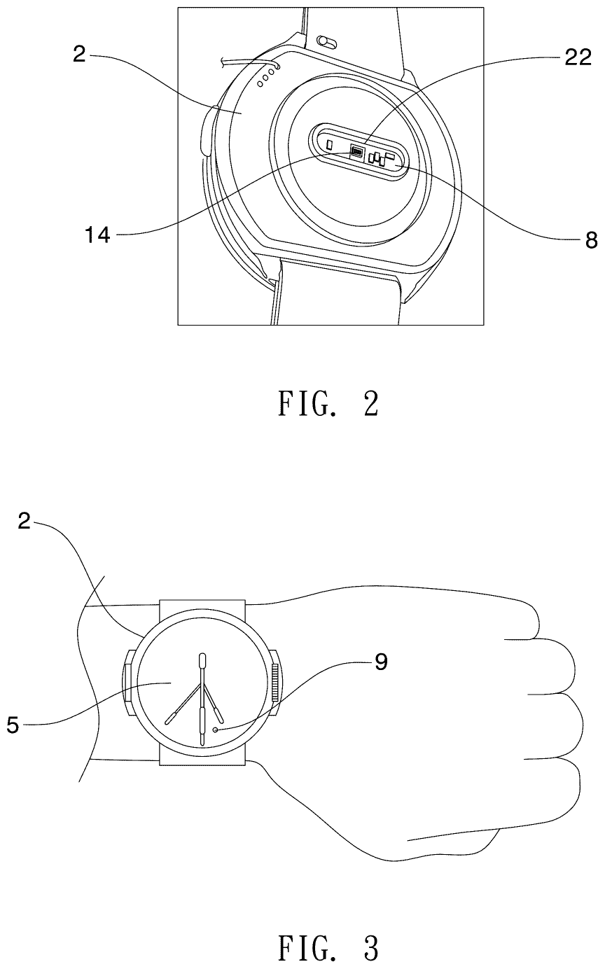

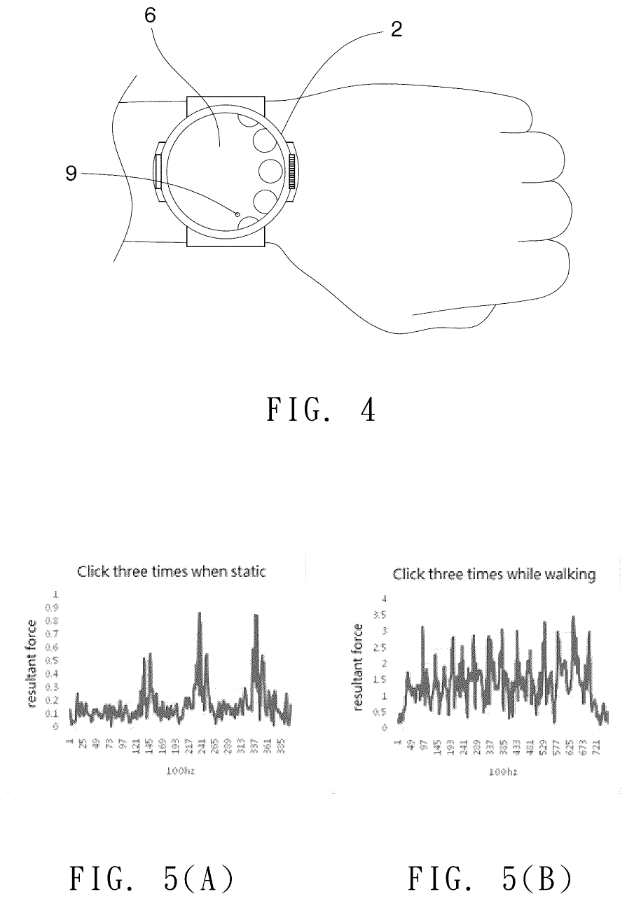

Referring to FIGS. 1 to 4, a preferred embodiment of the present invention, which is a one-hand operation system for a watch, comprises a smart watch 1, a multi-axis sensor 12, an optical sensor 14, and a processing unit 16. The smart watch 1, as is well-known, includes a time display and various digital functions and communication technologies. It consists of a watch body 2 and a watch band, with an operation unit 3 and a central control unit 4 electrically connected within the watch body 2. The operation unit 3 refers to the interface system within the smart watch that displays interactive screens and controls software applications, displaying a time screen 5 and a menu screen 6 on the watch's display. The time screen 5 shows the time and date, while the menu screen 6 displays multiple function blocks 7, each of which is an icon for clicking to activate different digital functions. The central control unit 4 contains hardware, such as a processor, memory, and circuit board (not shown), to control the operation of the operation unit 3. The bottom side of the watch body 2 is equipped with a transparent window 8 that corresponds to the wrist.

The components of the watch body 2, strap, operation unit 3, and central control unit 4 are conventional smart watch components and therefore are not described in detail here. However, this invention differs from known smart watches in the following ways: The operation unit 4 includes an unlock point 9, which can be displayed on both the time screen 5 and the menu screen 6. The function blocks 7 on the menu screen 6 are arranged in a serial order, but not limited to such. When the operation unit 4 is in an unlocked state, arm movements can cause the function blocks 7 to move up and down on the menu screen 6. When the function blocks 7 stop moving, the unlock point 9 corresponds to a preselected function block 7.

Additionally, the bottom of the watch body 2 includes a light transmission portion 22 corresponding to the transparent window 8. The light transmission portion 22 is a gap (approximately 0.7 mm, but not limited to this dimension) between the circuit board of the central control unit 4 and the transparent window 8, allowing external light and shadow changes to enter the interior of the watch body 2 through the transparent window 8 and the light transmission portion 22. The surface of the wrist is not flat, which allows external light to enter the watch body 2. Of course, the light transmission portion 22 is not limited to the aforementioned gap structure; it may also be a transparent case or an opening on one side of the watch body 2 (corresponding to the palm or fingers). The unlock point 9 is aligned with a preselected function block 7, making it easier for the user to click the function block 7 aligned with the unlock point 9 to activate its function.

In some cases, the operation unit 4 does not necessarily need an unlock point 9. The menu screen 6 can be designed such that when any function block 7 moves to its predetermined position (e.g., the center of the menu screen 6, but not limited to this position), the function block 7 will enlarge or blink, indicating that it is ready for selection when it stops moving.

The multi-axis sensor 12, located in the circuit board of the watch body 2, is a known six-axis sensor (IMU) used to detect vibration waves generated by finger pinching, releasing, and arm movement, so, the multi-axis sensor 12 detects finger pinching and releasing actions.

The optical sensor 14, located in the circuit board of the watch body 2 and corresponding to the light transmission portion 22 and transparent window 8, is a known optical sensor, such as a heart rate sensor with photoplethysmography (PPG) functionality, but not limited to this. It detects changes in external light and shadow (from the wrist area) during finger pinching, releasing, and arm movement via the light transmission portion 22, and so, the optical sensor 14 detects corresponding changes in light intensity during these gestures.

The processing unit 16, located in the central control unit 4 and electrically connected to the multi-axis sensor 12 and the optical sensor 14, includes an operation module 24 and a control module 26. The operation module 24 is a computational program that receives the detection signals from the multi-axis sensor 12 and the optical sensor 14 to calculate the vibration wave and light intensity information for different gestures. The control module 26 is a Convolutional Neural Network (CNN) model pre-trained using the three-axis linear acceleration data captured by the multi-axis sensor 12 through machine learning. The trained model, which has gesture recognition capabilities, is then deployed into the central control unit 4. This allows the operation module 24 to interpret finger and arm movements, such as pinching, releasing, or moving the arm, giving the smart watch 1 the ability to recognize gestures.

When a finger is pinched, the operation unit 3 enters an unlocked state, and when the finger is released, the operation unit 3 enters a locked state. While unlocked, moving the arm can transition the operation unit 3 from the time screen 5 to the menu screen 6, or move the function blocks 7 in the menu screen 6. When the arm stops moving and the operation unit 3 is locked, the function blocks 7 stop moving, allowing the preselected function block 7 to be activated by a click.

Additionally, the term “click” refers to a rapid pinching and releasing of the finger, with the interval between the pinch and release not exceeding a predetermined time, which in this invention is set to 500 milliseconds. The operation module 24 specifically captures the three-axis acceleration data from the multi-axis sensor 12 between a first threshold and a second threshold, at a sampling frequency of 250 Hz, and determines whether the light intensity detected by the optical sensor 14 exceeds a third threshold.

The first and second thresholds are determined by excluding data with excessively low, excessively high, or prolonged acceleration values. This allows the control module to determine whether the finger is pinched. The term “too low” acceleration refers to the absolute value of the difference in the combined three-axis linear acceleration force not exceeding the first threshold value multiple times consecutively, which indicates movements like walking that are not gesture-related. The first threshold value is set at 0.18, which represents the minimum absolute difference in the combined force of the three-axis linear acceleration at different times. The second threshold value is set at 10, which represents the maximum absolute difference in the combined force of the three-axis linear acceleration at different times. The three-axis linear acceleration is obtained by subtracting the gravitational acceleration component on each axis from the three-axis acceleration data.

The third threshold is used by the control module 26 to determine if the finger is in a pinched state. It is calculated as the absolute difference between the light intensity detected by the optical sensor 14 at different times, multiplied by a factor, which is set to −0.5 to determine if the finger has been released.

The calculation and setting of the first threshold, second threshold, third threshold, and the three-axis acceleration data are described as follows:

100 Hz Sampling: Initially, if the three-axis acceleration data detected by the multi-axis sensor 12 is sampled at 100 Hz, obvious vibration waveforms caused by finger pinching and releasing actions can be observed. However, under adverse conditions such as walking or changes in the speed of the smart watch 1, the vibrations caused by clicking may be mixed with walking speed signals, making the click waveforms unclear, as shown in FIGS. 5(a) and (b). In FIG. 5(a), which shows the static case, three distinct click waveforms can be seen. In FIG. 5(b), during walking, the click waveforms become indistinct due to the interference from walking vibrations.

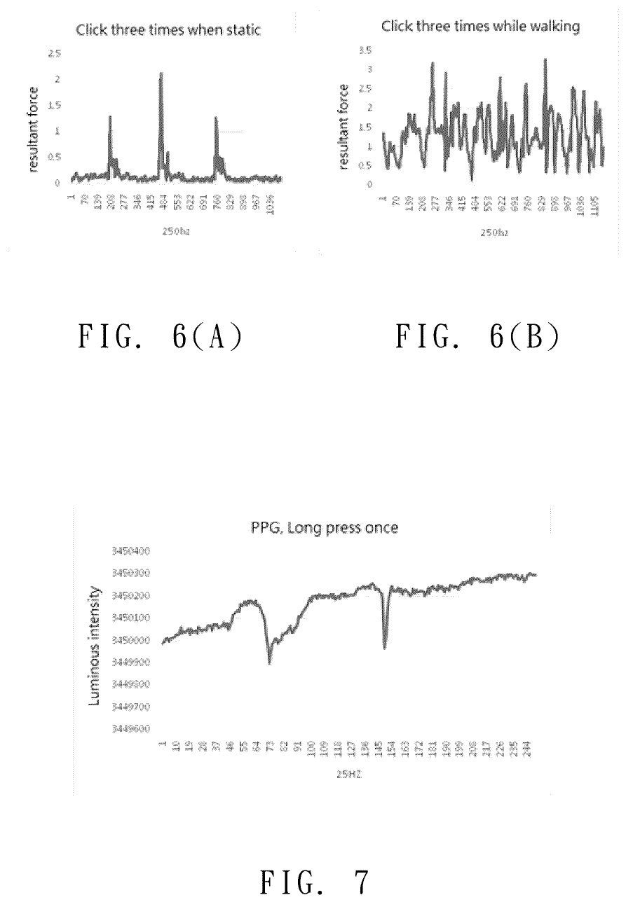

250 Hz Sampling for Clear Waveforms: To address this issue, after numerous experiments, the present invention samples the three-axis acceleration data using a 250 Hz IMU, which results in more distinct click waveforms. As shown in FIGS. 6(a) and (b), high-frequency vibration waveforms from clicking can be seen in the regions 302-345, 603-646, and 818-861. By increasing the sampling frequency to 250 Hz, click gesture waveforms can be extracted under dynamic conditions. However, gestures with smaller vibrations, such as long-pressed pinching without releasing, remain difficult to recognize solely using the multi-axis sensor 12. In such cases, the invention supplements the multi-axis sensor with the optical sensor 14.

Optical Sensor for Fine Detection: As shown in FIG. 7 (with light intensity measured in candela, cd), during a long press and release of the thumb and forefinger, the optical sensor 14 detects distinct secondary fluctuations in the waveform. These fluctuations occur between the regions 61-81 for pressing and 141-151 for releasing. Thus, with the aid of the optical sensor 14, the system can more precisely distinguish between pinching, holding, and releasing gestures. This compensates for the multi-axis sensor 12's difficulty in accurately detecting whether the pinched finger has been released.

Gravity Compensation: Additionally, the acceleration data collected by the multi-axis sensor 12 must account for the effect of gravity. The invention calculates the quaternion from angular velocity to obtain the gravity component, and then subtracts the gravity component from the three-axis acceleration data to obtain the linear acceleration, effectively eliminating gravity's impact on the actual acceleration. Furthermore, the acceleration data undergoes filtering to remove noise.

When calculating and setting the first threshold and second threshold values, as shown in Equation (1), the combined force Aₜₒₜₐₗ of the three-axis linear acceleration x, y, z is first calculated to eliminate the positive and negative differences in the acceleration data, which helps improve the consistency and reliability of the data. The equation is as follows:

$${A}_{total} = \sqrt{{x}^{2} + {y}^{2} + {z}^{2}} \qquad ( 1 )$$

Next, as shown in Equation (2), the difference between the neighboring total forces Aₜₒₜₐₗ(t) [symbol] Aₜₒₜₐₗ(t−1) is calculated to get the absolute value D (t) of the difference. The equation is as follows:

$${D}_{acc} ( t ) = \vert {A}_{total} ( t ) - {A}_{total} ( t - 1 ) \vert \qquad ( 2 )$$

The inventor analyzed the waveform of these differences and observed that during finger pinching and releasing, the absolute values of these differences remain within a fixed range. Therefore, the minimum and maximum absolute values of the difference in the combined force of the three-axis linear acceleration are defined as the first threshold

$$( {D}_{acc}^{threshold} = 0.18 )$$

and the second threshold

$$( {D}_{acc}^{max} = 10 ,$$

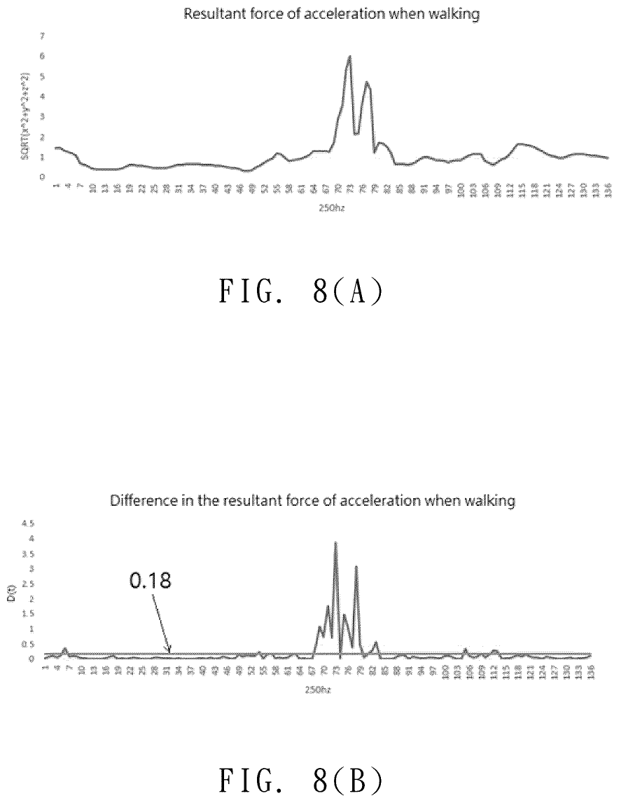

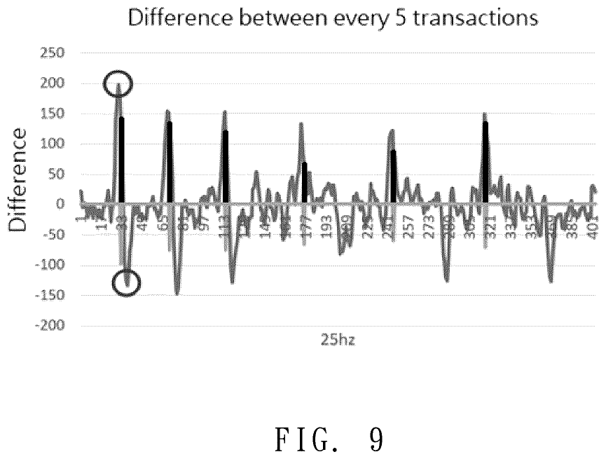

as shown in Equation (3). These thresholds are used to determine whether a hand movement has occurred. As illustrated in FIGS. 8(a) and (b), one click waveform is collected while walking, where the combined force difference exceeds the first threshold

$${D}_{acc}^{threshold}$$

at the 68th sample.

Next, as shown in Equation (4), check whether the absolute value D_{acc}(t) exceeds the first threshold for five consecutive times (from the 68th to the 72nd sample). If it does, the sixth sample D_{acc}(T) (i.e., the 73rd sample in FIG. 8) that exceeds the first threshold is designated as the center of the retrieved waveform

$${D}_{acc}^{middle} ,$$

as defined in Equation (5). The center time point is set to T=t+5. From T−11 to T+12 (i.e., samples 62 to 85 in FIG. 8), a total of 24 strokes of triaxial linear acceleration data were extracted, as in equation (6). During this period, if the value exceeds the second threshold

$${D}_{acc}^{max} ,$$

it is disregarded, as shown in Equation (6), to eliminate excessive and prolonged accelerations due to sudden arm movements, to avoid misjudging non-gesture actions, and to check that the last 5

$$( {D}_{acc} ( t ) {\vert}_{T + 8}^{T + 12} )$$

out of the 24 samples

$$( {D}_{acc} ( t ) {\vert}_{T - 11}^{T + 12} )$$

captured drop back below the first threshold

$${D}_{acc}^{threshold}$$

as in equation (7). Only when these conditions are met is the three-axis acceleration data transmitted to the central control unit 4 for storage and gesture recognition by the control module 26, as described in Equation (8). This ensures that the multi-axis sensor 12 only sends valid gesture data to the central control unit 4, thus minimizing distortions and unnecessary data transmission during walking.

$$Define first {threshold D}_{acc}^{threshold} = 0.18 , {secondthreshold D}_{acc}^{max} = 10 , , \qquad ( 3 )$$

$$if {D}_{acc} ( t ) {\vert}_{t}^{t + 4} > {D}_{acc}^{threshold} , Set T = t + 5 \qquad ( 4 )$$

$$Get {D}_{acc} ( t ) {\vert}_{T - 11}^{T + 12} , {while D}_{acc}^{middle} = {D}_{acc} ( T ) \qquad ( 5 )$$

$$if {D}_{acc} ( t ) {\vert}_{T - 11}^{T + 12} > {D}_{acc}^{max} , Discard {D}_{acc} ( t ) {\vert}_{T - 11}^{T + 12} , end . \qquad ( 6 )$$

$$if {D}_{acc} ( t ) {\vert}_{T + 8}^{T + 12} > {D}_{acc}^{threshold} , Discard {D}_{acc} ( t ) {\vert}_{T - 11}^{T + 12} , end . \qquad ( 7 )$$

$$Finally , Store time series D ( t ) {\vert}_{T - 11}^{T + 12} for machine learning . \qquad ( 8 )$$

### Optical Sensor PPG Calculation:

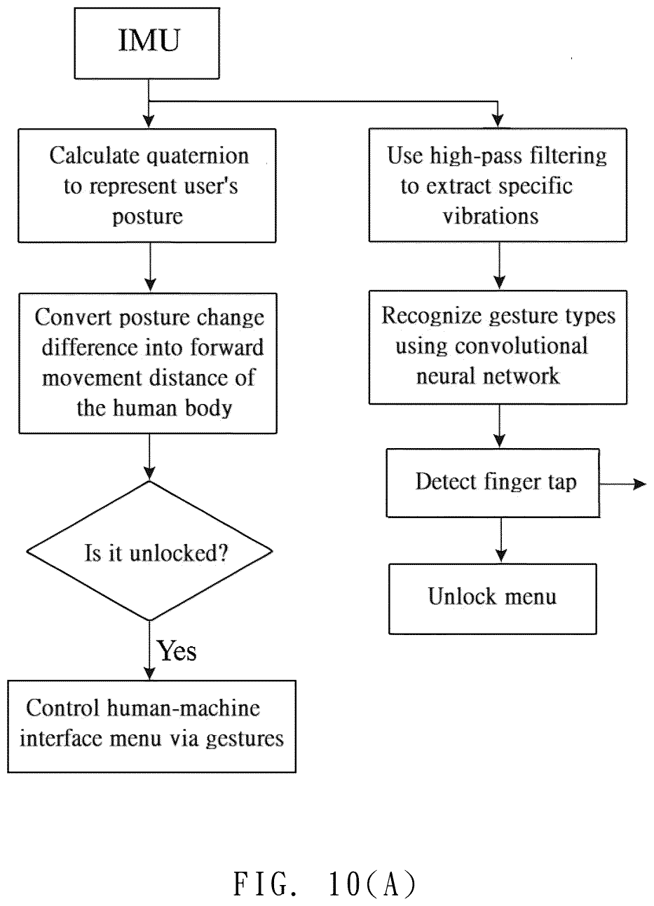

Additionally, as shown in FIG. 9, the difference of the time series PPG (t) read by the optical sensor 14 is denoted as D_{PPG}(t)), which is calculated by subtracting the PPG value from five samples earlier using Equation (9):

$${D}_{PPG} ( t ) = PPG ( t ) - PPG ( t - 5 ) \qquad ( 9 )$$

When the multi-axis sensor 12 detects finger pinching, the optical sensor 14 captures the maximum PPG value. Using Equation (9), the maximum PPG difference D_{PPG}(t) is multiplied by a constant value D_{PPG}(t) of −0.5 to establish the third threshold

$${D}_{PPG}^{threshold} ,$$

as shown in Equation (10). When the absolute value of D_{PPG}(t) exceeds this threshold, it is identified as a “release” gesture, as defined in Equation (11).

$${D}_{PPG}^{threshold} = - 0.5 * {D}_{PPG} ( t ) \qquad ( 10 )$$

$$if \vert {D}_{PPG} ( t ) \vert > \vert {D}_{PPG}^{threshold} \vert , Set gesture release \qquad ( 11 )$$

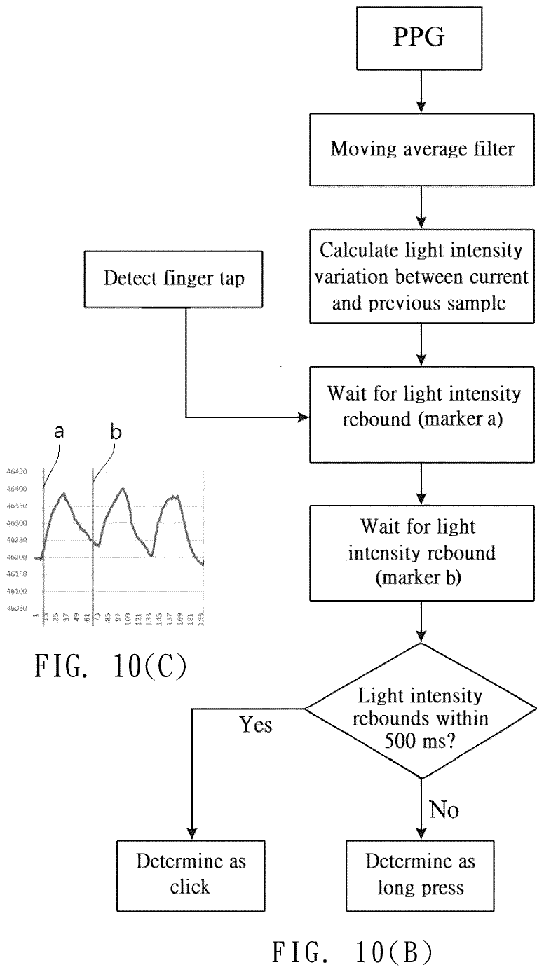

Based on these parameters, the central control unit 4 will store the third threshold. When the PPG intensity detected by the optical sensor 14 rebounds past this threshold, it is recognized as the release of the finger. Additionally, the central control unit 4 calculates the time interval between the pinch and release. If the interval is within 500 milliseconds, the system recognizes it as a rapid pinch and release click action, triggering the function associated with the unlocking point 9, as shown in FIGS. 10(a), 10(b) and 10(c).

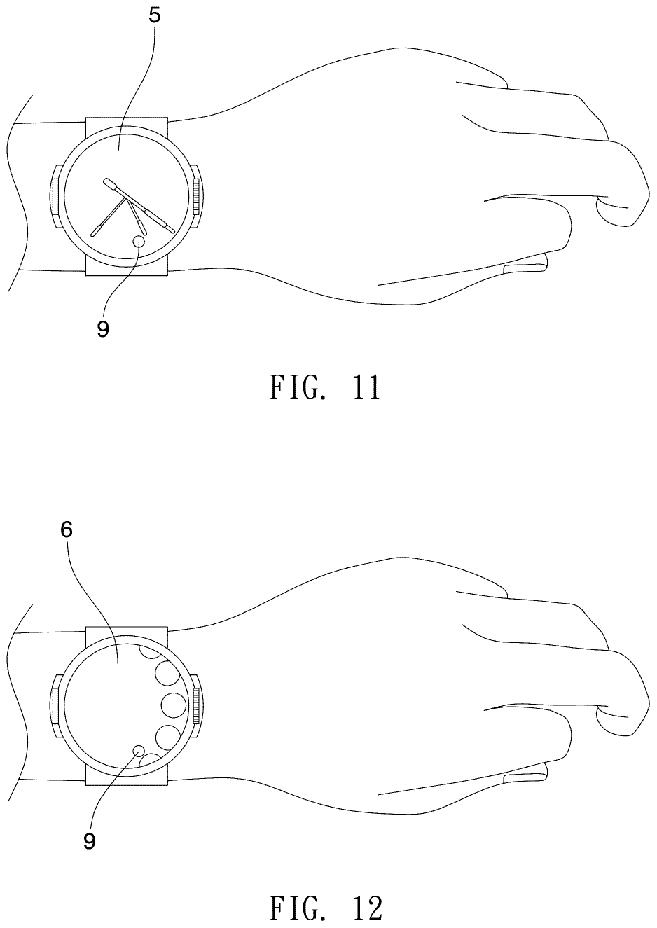

In this manner, the present invention provides a one-handed operation system for a smart watch, enabling users to perform one-handed operations in an intuitive manner through gesture recognition (pinching and releasing of the fingers) combined with somatosensory feedback (movement of the arm). As shown in FIG. 11, when the smart watch 1 displays the time screen 5, pinching the fingers unlocks the operation unit 3, with the unlocking point 9 appearing enlarged. By keeping the fingers pinched and moving the arm forward (in the direction of the fingers), the operation unit 3 transitions from the time screen 5 to the menu screen 6, as shown in FIG. 12. Conversely, when the menu screen 6 is displayed, pinching the fingers to unlock the operation unit 3 and moving the arm backward (towards the elbow) returns the operation unit 3 to the time screen 5. When the fingers are released, the operation unit 3 reverts to a locked state, and the unlocking point 9 returns to its original size, thereby preventing further operation of the unit through arm movement.

When the smart watch 1 is displaying the menu screen 6, pinching the fingers to unlock the operation unit 3 and then moving the arm up or down (i.e., away from or towards the body) allows the function blocks 7 in the menu screen 6 to move accordingly. Once the arm stops moving and the function blocks 7 come to a halt, a quick pinching and releasing action of the fingers activates the function block 7 aligned with the unlocking point 9.

Thus, the present invention simulates the operation of tapping on a touch screen through the action of pinching, and releasing the fingers is equivalent to removing the fingers from the touch screen. The somatosensory feedback (movement of the arm) simulates the sliding action of fingers on a touch screen.

In summary, since the multi-axis sensor primarily detects vibration waves generated by movements and changes in posture, it is challenging to differentiate subtle gesture actions under dynamic conditions. By combining the optical sensor and the multi-axis sensor, the present invention utilizes both sensors' detection results to perform calculations and judgments within the processing unit. This enables the system to determine whether the arm is moving and recognize gestures in both static and dynamic conditions, thereby allowing intuitive control of the smart watch through simple one-handed gestures and somatosensory movements. This approach is more convenient and efficient than the familiar finger-tap operation method of existing smart watches, and it does not require the user to memorize multiple operating gestures, making it simpler to use compared to the technology disclosed in U.S. Pat. No. 9,971,313. Furthermore, the smart watch screen in the present invention can utilize a standard LCD display instead of a touch screen LCD, thereby reducing production costs.

The above description is merely a preferred embodiment of the present invention and is not intended to limit its scope. Any modifications, alterations, or improvements made by a person of ordinary skill in the art, without departing from the spirit and scope of the invention, shall be considered within the protection scope defined by the appended patent claims.

1. A one-hand operation system for a watch, comprising:
a smart watch comprising a watch body and a strap, with an operating unit and a central control unit electrically connected to the watch body, wherein the operating unit is configured to display a time screen and a menu screen on the watch body, the menu screen comprising a plurality of function blocks, the central control unit being configured to control the operation of the operating unit, and there being a light-transmitting section on one side of the watch body corresponding to a wrist, a hand, or a finger;
a multi-axis sensor disposed within the watch body and configured to detect vibration waves generated by the actions of finger pinching, releasing, and arm movement;
an optical sensor disposed within the watch body and corresponding to the light-transmitting section, configured to detect changes in light through the light-transmitting section during the processes of finger pinching, releasing, and arm movement; and
a processing unit, disposed within the central control unit and electrically connected to the multi-axis sensor and the optical sensor, comprising an algorithm module and a control module, wherein the algorithm module is configured to receive detection signals from the multi-axis sensor and optical sensor, calculate vibration waves and light intensity information corresponding to different gesture movements, and the control module is connected to the algorithm module and configured to recognize the movements of fingers and arms as pinching, releasing, or moving the arm, and consequently to unlock the operation unit when the fingers are pinched and lock the operation unit when the fingers are released, with the operation unit being movable by moving the arm to enter the menu screen or to move the function blocks within the menu screen, and each function block stopping movement when the arm stops moving and the operation unit is locked, thereby allowing a predetermined function block to be activated by clicking.

2. The one-handed operation system for a watch as claimed in claim 1, wherein the light transmitting section is located on the bottom side of the watch body to correspond to the wrist.

3. The one-handed operating system for watches as claimed in claim 1, wherein the light-transmitting section is located on one side of the watch body to correspond to the palm or fingers.

4. The one-handed operation system for watches as described in claim 1, wherein the function blocks of the menu screen are arranged in series, and when the operation unit is unlocked, moving the arm enables the function blocks to move up and down on the menu screen.

5. The one-handed operation system for watches as described in claim 4, wherein when the function blocks stop moving, the central control unit is configured to zoom in on the predefined function blocks for selection and activation.

6. The one-handed operation system for watches as described in claim 5, wherein the control module is configured to enable the enlarged function block to be activated by a short, rapid pinch and release action of the finger.

7. The one-handed operating system for watches as claimed in claim 4, wherein the operating unit comprises an unlocking point, and the function block corresponding to the unlocking point can be optionally activated when the function blocks stop moving.

8. The one-hand operation system for watches as described in claim 7, wherein the control module is configured to enable the function block corresponding to the unlocking point to be activated by a quick pinch and release action of a finger within a short period of time.

9. The one-hand operation system for watches as described in claim 1, wherein the multi-axis sensor is a six-axis sensor, and the optical sensor is an optical sensor with photoplethysmography (PPG) functionality.

10. The one-hand operation system for watches as claimed in claim 9, wherein the algorithm module is configured to capture three-axis acceleration data detected by the multi-axis sensor between a first threshold and a second threshold and to calculate whether the light intensity detected by the optical sensor exceeds a third threshold, for the control module to determine whether the finger is pinched or released based on the results of the algorithm module.

11. The one-handed operation system for watches as claimed in claim 10, wherein the first and second thresholds are obtained by deleting three-axis acceleration data of excessively low, excessively high, and prolonged acceleration for the control module to judge whether the finger is pinched or released.

12. The one-handed operation system for watches as described in claim 11, wherein the first threshold is the minimum absolute value of the difference between the combined forces of the three axes of linear acceleration at different times, the second threshold is the maximum absolute value of the difference between the combined forces of the three axes of linear acceleration at different times, and the three-axis linear acceleration is obtained by subtracting the gravitational component from the respective axes.

13. The one-hand operation system for watches as claimed in claim 12, wherein the first threshold is set to 0.18 and the second threshold is set to 10.

14. The one-handed operation system for watches as described in claim 11, wherein the excessively low acceleration is defined as three-axis acceleration data in which the absolute value of the difference in the combined three-axis linear acceleration does not exceed the first threshold value for several consecutive times and represents acceleration not caused by gestural actions such as walking.

15. The one-hand operation system for watches as claimed in claim 12, wherein the frequency of the three-axis acceleration data detected by the multi-axis sensor is set to 250 Hz.

16. The one-handed operating system for watches as described in claim 1, wherein the control module is a Convolutional Neural Network (CNN) model that is trained using the tri-axial linear acceleration data captured by the multi-axis sensors to have the ability to determine which gesture the tri-axial linear acceleration data corresponds to.

17. The one-handed operation system for watches as described in claim 10, wherein the third threshold is defined as the absolute value of the difference between the light intensity detected by the optical sensor and the light intensity detected by the optical sensor at different times when the control module determines that the finger is pinched, multiplied by a value for the control module to determine whether the finger is released.

18. The one-handed operation system for watches as described in claim 17, wherein the value is set to −0.5.

19. The one-handed operation system for watches as claimed in claim 7, wherein the short period of time refers to the interval between the pinching and releasing of the finger not exceeding a predetermined period.

20. The one-hand operation system for watches as claimed in claim 19, wherein the predetermined period is set to 500 milliseconds.
